(19) United States
(12) Patent Application Publication
(10) Pub. No.: US 2008/0145005 A1
(43) Pub. Date: Jun. 19, 2008

(54) Optical communication module and optical sub-assembly

(76) Inventors: Masahiro Shibata, Chigasaki-shi (JP); Masakazu Shigehara, Chigasaki-shi (JP)

Correspondence Address: MCDERMOTT WILL & EMERY LLP, 600 13TH STREET, N.W., WASHINGTON, DC, 20005-3096, US

(21) Appl. No.: 12/000,653

(22) Filed: Dec. 14, 2007

Related U.S. Application Data
(60) Provisional application No. 60/877,002, filed on Dec. 26, 2006.

(30) Foreign Application Priority Data
Dec. 15, 2006 (JP) P2006-338913

(51) Int. Cl. G02B 6/36

(52) U.S. Cl. 385/92

(57) ABSTRACT

The present invention provides an optical communication module and an optical subassembly which can suppress leakage of electromagnetic waves. An optical communication module includes: a receptacle section for insertion of an optical connector plug; a casing section which is connected to the receptacle section and houses a circuit board; and an optical transmission subassembly and an optical receive subassembly, which are optically coupled with the optical connector plug and are electrically connected to the circuit board. At least a part of the receptacle section, at least a part of the casing section, at least a part of the optical transmission subassembly, or at least a part of the optical receive subassembly is formed of a resin containing an additive which has electromagnetic wave absorption properties.

### CROSS REFERENCE TO RELATED APPLICATIONS

This application is based upon and claims the benefit of priorities from the prior Japanese Patent Application No. 2006-338913, filed on Dec. 15, 2006 and provisional U.S. application No. 60/877002, filed on Dec. 26, 2006, the entire contents of which are incorporated herein by reference.

### FIELD OF THE INVENTION

The present invention relates to an optical communication module and an optical subassembly.

### BACKGROUND ART

An optical communication module comprises an optical transmission subassembly, optical receive subassembly, circuit board, receptacle and casing. The optical transmission subassembly has a light emitting element which generates light, and the optical receive subassembly has a light receiving element for receiving light. The circuit board, on which a driver IC and other elements are mounted, is electrically connected with the light emitting element and light receiving element. The casing is formed so as to cover the optical transmission subassembly, optical receive subassembly and circuit board. The receptacle has opening sections for optically coupling an optical fiber to the light emitting element and light receiving element respectively. An optical connector plug holding an optical fiber is inserted into the opening section of the receptacle. For such an optical communication module, a metal casing is used to prevent the emission of electromagnetic waves to the outside. The technology is disclosed, for example, in Japanese Patent Application Laid-Open No. 2004-212709.

However in the above mentioned optical communication module, of which casing is made of metal by combining a plurality of metal plates, electromagnetic waves leak through gaps between metal plates.

### SUMMARY OF THE INVENTION

With the foregoing in view, it is an object of the present invention to provide an optical communication module and an optical subassembly which can suppress leakage of electromagnetic waves.

An optical communication module of the present invention comprises: a receptacle section for insertion of an optical connector plug; a casing section which is connected to the receptacle section and houses a circuit board; and an optical subassembly which is optically coupled with the optical connector plug and is electrically connected to the circuit board, wherein at least a part of the receptacle section, at least a part of the casing section, or at least a part of the optical subassembly is formed of a resin containing an additive which has electromagnetic wave absorption properties.

An optical communication module of the present invention comprises: a receptacle section for insertion of an optical connector plug; a casing section which is connected to the receptacle section and houses a circuit board; and an optical subassembly which is optically coupled with the optical connector plug and is electrically connected to the circuit board; and a holding section for holding the optical subassembly to the casing section or the receptacle, wherein at least a part of the receptacle section, at least a part of the casing section, at least a part of the optical subassembly, or at least a part of the holding section is formed of a resin containing an additive which has electromagnetic wave absorption properties.

The optical communication module uses a resin which can be easily processed, so the spaces between composing elements of the optical communication module can be decreased. Therefore according to the optical communication module of the present invention, electromagnetic waves that leak through these spaces can be suppressed.

It is preferable that the resin containing the additive absorbs electromagnetic waves of which frequency is 1 GHz or more and 50 GHz or less. In this case, radiating noise from the optical communication module can be effectively suppressed.

It is preferable that the additive is a fine powder of iron, iron oxide, carbon or stainless. It is also preferable that the additive is a fine powder comprising two or more materials from among iron, aluminum, cobalt and silicon. The additive may be a fine powder of aluminum, cobalt or silicon.

It is preferable that the resin is a polyamide resin, PBT resin, PPS resin, LCP resin or PEEK resin. In this case, components having an electromagnetic absorption function can be provided at low cost by injection molding.

An optical subassembly of the present invention comprises: a photo-electric conversion element; and a casing for housing the photo-electric conversion element, wherein at least a part of the casing is formed of a resin containing an additive which has electromagnetic absorption properties.

The optical subassembly of the present invention uses a resin of which can be easily processed, so the spaces between the optical subassembly and the composing elements, other than the optical subassembly, can be decreased. Therefore according to the optical subassembly of the present invention, electromagnetic waves that leak through these spaces can be suppressed.

### BRIEF DESCRIPTION OF THE DRAWINGS

FIG. 1 is a perspective view depicting an optical communication device comprising an optical communication module according to the present embodiment;

FIG. 2 is an exploded perspective view depicting an optical communication module according to the present embodiment;

FIG. 3 is a plan view depicting the inside of an optical communication module according to the present embodiment;

FIG. 4 is a cross-sectional view depicting an optical subassembly according to the present embodiment; and

FIG. 5 is a cross-sectional view depicting an optical subassembly according to another embodiment.

### DETAILED DESCRIPTION

The embodiments of the present invention will now be described with reference to the accompanying drawings. In the description of the drawings, the same or equivalent elements are denoted with the same reference symbols, for which redundant description is omitted.

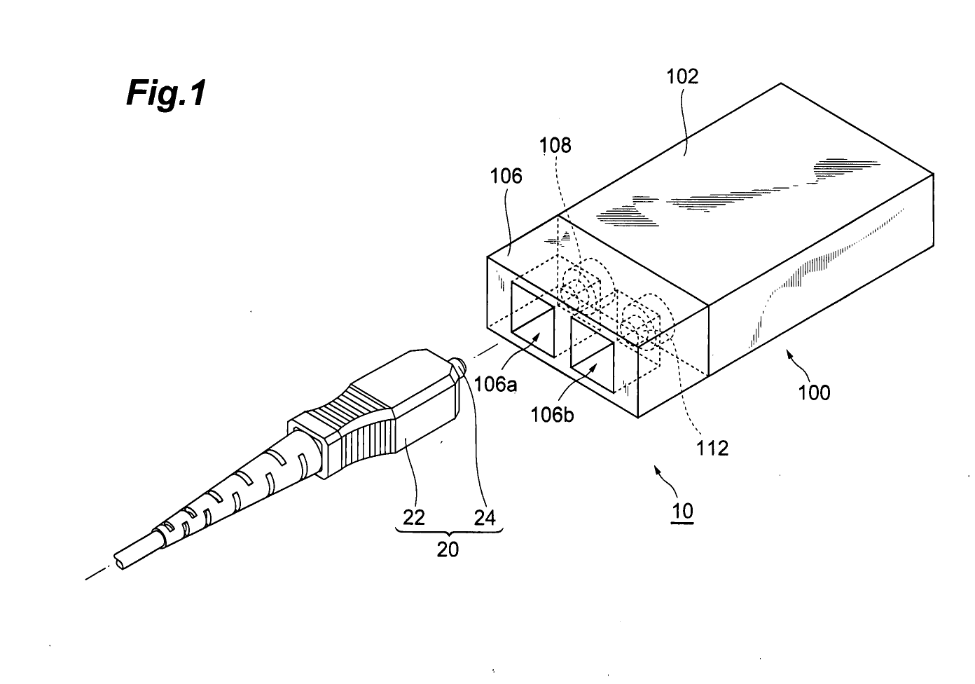

FIG. 1 is a perspective view depicting an optical communication device comprising an optical communication module according to the present embodiment. The optical communication device 10 shown in FIG. 1 comprises an optical communication module 100, and an optical connector plug 20 which is inserted into an opening section 106a or an opening section 106b of a receptacle section 106 of the optical communication module 100. For example, two optical connector plugs 20 are inserted into the opening section 106a and the opening section 106b respectively. For the optical communication module 100, an optical transceiver, for example, can be used. In the opening section 106a, an optical transmission subassembly 108 (optical subassembly: OSA), which is optically coupled with the optical connector plug 20, is disposed. In the opening section 106b, an optical receive subassembly 112 (optical subassembly), which is optically coupled with the optical connector plug 20, is disposed.

The optical connector plug 20 transmits an optical signal from the optical communication module 100, or transmits an optical signal from the outside to the optical communication module 100. The optical connector plug 20 may be any one of an SC type optical connector plug, MU type optical connector plug and LC type optical connector plug. The optical connector plug 20 comprises a casing 22, a ferrule 24 housed in the casing 22, and an optical fiber housed in the ferrule 24. The ferrule 24 protrudes from the casing 22 toward the optical communication module 100 side. A cable, which is optically coupled with the optical fiber, is connected to the casing 22.

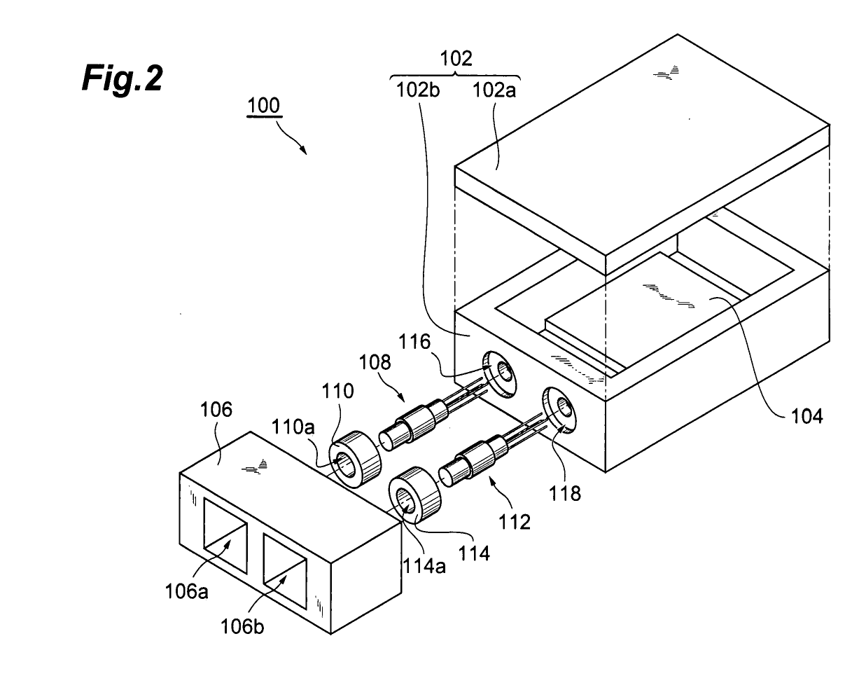

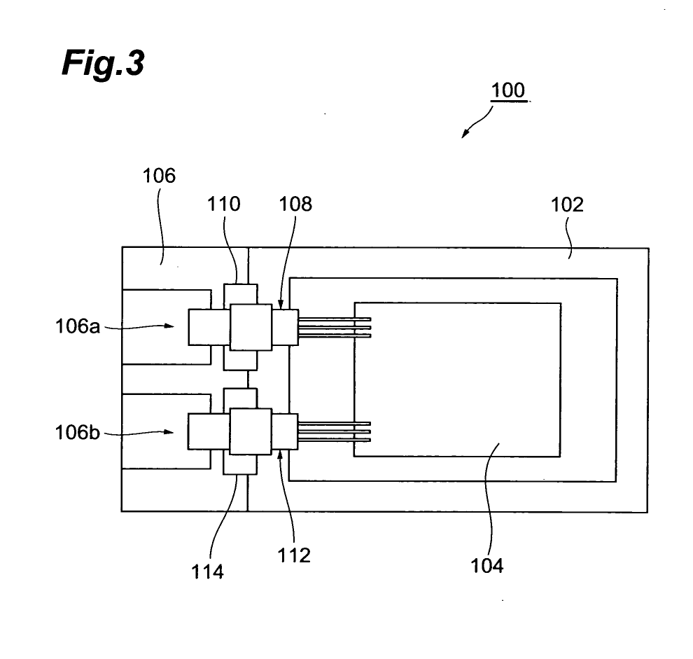

FIG. 2 is an exploded perspective view depicting the optical communication module according to the present embodiment. FIG. 3 is a plan view depicting the inside of the optical communication module according to the present embodiment.

The optical communication module 100 shown in FIG. 1 to FIG. 3 comprises a receptacle section 106 for inserting the optical connector plug 20, a casing section 102 which is connected to the receptacle section 106 and houses a circuit board 104, and an optical transmission subassembly 108 and an optical receive subassembly 112, which are optically coupled with the optical connector plug 20 and are electrically connected to the circuit board 104. The optical communication module 100 also has a holding section 110 which holds the optical transmission subassembly 108 in the casing section 102 or in the receptacle section 106, and a holding section 114 which holds the optical receive subassembly 112 in the casing section 102 or in the receptacle section 106.

The casing section 102 has a box 102b which houses the circuit board 104 and a cover 102a which closes the opening of the box 102b.

The circuit board 104 is an electronic circuit board on which such an element as a driver IC for driving light emitting elements is mounted. The circuit board 104 is electrically connected to the optical transmission subassembly 108 and optical receive subassembly 112, so the optical communication module 100 generates electromagnetic waves from the elements and wires therein.

The optical transmission subassembly 108 is a device for outputting an optical signal, and has such a light emitting element as a semiconductor laser. The optical receive subassembly 112 is a device for receiving an optical signal, and has such a light receiving element as a photo-diode. Therefore the optical transmission subassembly 108 and the optical receive subassembly 112 generate electromagnetic waves from the elements and wires therein.

One end of the optical transmission subassembly 108 is inserted into the opening 110a of the holding section 110, and is optically coupled with the optical connector plug 20. The holding section 110 is a cylindrical shape, for example. The other end of the optical transmission subassembly 108 is inserted into the opening 116 formed on the side face of the box 102b of the casing section 102, and is electrically connected to the circuit board 104. One end of the optical receive subassembly 112 is inserted into the opening 114a of the holding section 114, and is optically coupled with the optical connector plug 20. The holding section 114 is a cylindrical shape, for example. The other end of the optical receive subassembly 112 is inserted into the opening 118 formed on the side face of the box 102b of the casing section 102, and is electrically connected to the circuit board 104.

The receptacle 106 has two opening sections: 106a and 106b. In the two opening sections 106a and 106b, the optical transmission subassembly 108 and the optical receive subassembly 112 are housed respectively. In the opening sections 106a and 106b of the receptacle section 106, the optical connector plug 20 is inserted. By this, the optical connector plug 20 is optically coupled with the light emitting element of the optical transmission subassembly 108, or with the light receiving element of the optical receive subassembly 112.

In the present embodiment, at least a part of the receptacle section 106, at least a part of the casing section 102, at least a part of the optical transmission subassembly 108, at least a part of the optical receive subassembly 112 or at least a part of the holding sections 110 and 114 is formed of resin. It is preferable that the receptacle section 106, casing section 102 and holding sections 110 and 114 are formed of the resin containing the additive. One or more section of the receptacle section 106, casing section 102 and holding sections 110 and 114 may be formed of the resin containing an additive. The two or more sections of the receptacle section 106, casing section 102 and holding sections 110 and 114 may be integrated.

The elements formed of the resin containing the additive can be obtained by cutting bulk material into a predetermined shape or by molding using a die, for example. For forming a part of an element of the resin containing the additive, insert molding, for example, can be used.

If the casing section 102 is formed of a resin containing an additive that has electromagnetic absorption properties, most of the electromagnetic waves generated from the circuit board 104 can be absorbed. If the holding section 110 is formed of a resin containing the additive, most of the electromagnetic waves generated from the circuit board 104 and optical transmission subassembly 108 can be absorbed. If the holding section 114 is formed of a resin containing the additive, most of the electromagnetic waves generated from the circuit board 104 and optical receive subassembly 112 can be absorbed. When the receptacle section 106 is formed of a resin containing the additive, the spread of electromagnetic waves generated from the optical transmission subassembly 108 and optical receive subassembly 112 into a peripheral area can be suppressed. If a part of the optical transmission subassembly 108 is formed of a resin containing the additive, most of the electromagnetic waves generated from the circuit board 104 and optical transmission subassembly 108 can be absorbed. If a part of the optical receive subassembly 112 is formed of a resin containing the additive, most of the electromagnetic waves generated from the circuit board 104 and optical receive subassembly 112 can be absorbed.

It is preferable that the resin is used as a main material. Examples of this resin are polyamide resin, PBT (polybutyleneterephthalate) resin, PPS (polyphenylenesulfide) resin, LCP (liquid crystal polyester) resin, and PEEK (polyetheretherketone) resin, epoxy resin and acrylate resin. In particular, if polyamide resin, PBT resin, PPS resin, LCP resin or PEEK resin is used as the resin, the elements having an electromagnetic wave absorption function can be provided at low cost by injection molding. If an acrylate resin, which has fluidity, is used, the electromagnetic wave absorption layer can be formed on the surface of an arbitrary element by coating.

For the additive, fine powder of iron, aluminum, cobalt, silicon, iron oxide, carbon or stainless can be used. A fine powder allow comprised of two or more materials out of iron, aluminum, cobalt and silicon can also be used as the additive. These additives can absorb electromagnetic waves by converting electromagnetic waves into heat.

It is preferable that resin containing an additive absorbs electromagnetic waves of which frequency is 1 GHz or more and 50 GHz or less. In this case, the radiating noise from the optical communication module can be effectively suppressed.

According to the optical communication module 100 of the present embodiment, a resin which can be easily processed is used, so the spaces between composing elements of the optical communication module 100 can be decreased. Therefore according to the optical communication module 100, electromagnetic waves that leak through the spaces can be suppressed. Also flexibility in design can be improved since resin which can be easily processed is used.

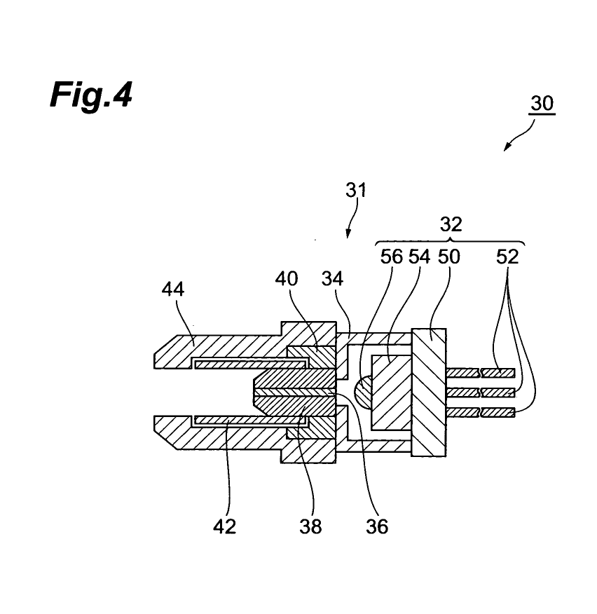

FIG. 4 is a cross-sectional view depicting an optical subassembly according to the present embodiment. The optical subassembly 30 shown in FIG. 4 can be used as the above mentioned optical transmission subassembly 108 or optical receive subassembly 112. The optical subassembly 30 comprises a photo-electric conversion element 32, and a casing 31 which houses the photo-electric conversion element 32.

The photo-electric conversion element 32 comprises a substrate 50, an element main unit 54 formed on the substrate 50, a lens 56 formed on the element main unit 54, and pins 52 which are electrically connected to the element main unit 54 via inside the substrate 50. If the element main unit 54 is a light emitting element, the optical subassembly 30 becomes an optical transmission subassembly. If the element main unit 54 is a light receiving element, the optical subassembly 30 becomes an optical receive subassembly.

The casing 31 has a casing section 34 which surrounds the element main unit 54 and the lens 56 on the substrate 50. The casing section 34 has a cylindrical shape, for example. In the casing section 34, an opening is formed so as to face the lens 56. In the opening, an edge of the optical fiber 36 is disposed. By this, the light irradiating from the lens 56, for example, enters the edge of the optical fiber 36. The light irradiating from the edge of the optical fiber 36 enters the lens 56, for example.

The casing 31 further comprises a stub 38 for holding an optical fiber 36, a stub holder 40 for holding one end of the stub 38 to the casing section 34, a sleeve 42 formed at the other end of the stub 38, and a sleeve case 44 for housing the sleeve 42. The stub 38, sleeve 42 and sleeve case 44 have cylindrical shapes, for example.

According to the present embodiment, at least a part of the casing 31 is formed of a resin containing the additive which has electromagnetic absorption properties. It is preferable that at least a part of the casing section 34, at least a part of the stub 38, at least a part of the stub holder 40, at least a part of the sleeve 42, or at least a part of the sleeve case 44 is formed of a resin containing the additive. The casing section 34, stub 38 and stub holder 40 may be formed of metal. The sleeve 42 may be formed of ceramic. The sleeve case 44 may be formed of metal or resin. At least one section of the casing section 34, stub 38, stub holder 40, sleeve 42 and sleeve case 44 may be formed of resin which contains the additive. Two or more sections of the casing section 34, stub 38, stub holder 40, sleeve 42 and sleeve case 44 may be integrated.

According to the optical subassembly 30 of the present embodiment, resin which can be easily processed is used, so the spaces between the optical subassembly 30 and elements other than the optical subassembly 30 (e.g. casing section 102) can be decreased in the optical communication module 100. Therefore according to the optical subassembly 30 of the present embodiment, electromagnetic waves that leak through the spaces can be suppressed. Also flexibility in design can be improved since resin which can be easily processed is used.

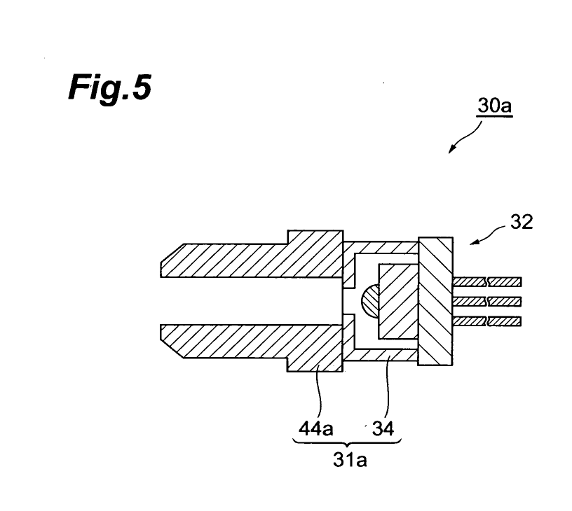

FIG. 5 is a cross-sectional view depicting an optical subassembly according to another embodiment. The optical subassembly 30a shown in FIG. 5 can be used as the above mentioned optical transmission subassembly 108 or the optical receive subassembly 112.

The optical subassembly 30a has a casing 31a comprising a casing section 34 and a sleeve case 44a which is connected to the casing section 34, instead of the casing 31 of the optical subassembly 30. The sleeve case 44a also plays a part of the sleeve. The sleeve case 44a has a cylindrical shape, for example.

According to the present embodiment, at least a part of the casing 31a is formed of a resin which contains the additive. It is preferable that at least a part of the casing section 34 and at least a part of the sleeve case 44a is formed of a resin containing an additive. The sleeve case 44a may be formed of metal, resin or ceramic. The inner surface of the sleeve case 44a may be formed of ceramic. One or both of the casing section 34 and the sleeve case 44a may be formed of the resin containing the additive. The casing section 34 and the sleeve case 44a may be integrated.

According to the optical subassembly 30a of the present embodiment, a functional effect the same as the optical subassembly 30 can be obtained. An optical fiber is not required in the case of the optical subassembly 30a.

The present invention is not limited to the above embodiments, but can be modified in various ways. For example, the optical communication module 100 need not have the holding sections 110 and 114. In this case, at least a part of the receptacle section 106, at least a part of the casing section 102, at least a part of the optical transmission subassembly 108, or at least a part of the optical receive subassembly 112 is formed of resin containing an additive which has electromagnetic wave absorption properties. In this case, the spaces between composing elements constituting the optical communication module 100 can be decreased, so electromagnetic waves which leak through the spaces can be suppressed.

According to the present invention, an optical communication module and optical subassembly which can suppress leakage of electromagnetic waves can be provided.

What is claimed is:

1. An optical communication module, comprising:
a receptacle section for insertion of an optical connector plug;
a casing section which is connected to said receptacle section and houses a circuit board; and
an optical subassembly which is optically coupled with said optical connector plug and is electrically connected to said circuit board, wherein
at least a part of said receptacle section, at least a part of said casing section, or at least a part of said optical subassembly is formed of a resin containing an additive which has electromagnetic wave absorption properties.

2. An optical communication module, comprising:
a receptacle section for insertion of an optical connector plug;
a casing section which is connected to said receptacle section and houses a circuit board;
an optical subassembly which is optically coupled with said optical connector plug and is electrically connected to said circuit board; and
a holding section for holding said optical subassembly to said casing section or said receptacle section, wherein
at least a part of said receptacle section, at least a part of said casing section, at least a part of said optical subassembly, or at least a part of said holding section is formed of a resin containing an additive which has electromagnetic wave absorption properties.

3. The optical communication module according to claim 1, wherein said additive is a fine powder of iron, iron oxide, carbon or stainless.

4. The optical communication module according to claim 1, wherein said additive is a fine powder comprising two or more materials from among iron, aluminum, cobalt and silicon.

5. The optical communication module according to claim 1, wherein said resin is a polyamide resin, PBT resin, PPS resin, LCP resin or PEEK resin.

6. An optical subassembly, comprising:
a photo-electric conversion element; and
a casing for housing said photo-electric conversion element, wherein
at least a part of said casing is formed of a resin containing an additive which has electromagnetic wave absorption properties.
